(19) United States
(12) Patent Application Publication
(10) Pub. No.: US 2005/0161236 A1
(43) Pub. Date: Jul. 28, 2005

(54) Contour aerator

(76) Inventor: Kenneth McLin, Olive Hill, TN (US)

Correspondence Address: Deborah Murdock, 10437 Wynbrooke Lane, Collierville, TN, 38017, US

(21) Appl. No.: 10/984,574

(22) Filed: Nov. 9, 2004

Related U.S. Application Data
(60) Provisional application No. 60/518,622, filed on Nov. 10, 2003.

(51) Int. Cl. A01B 45/02

(52) U.S. Cl. 172/21

(57) ABSTRACT

A method and apparatus for aerating comprises a main frame, a draw bar or three point hitch coupled to the main frame and configured to couple a motorized device to the main frame. Each aerator unit is coupled to the main frame and is independently swingable to move the shafts between horizontal positions and positions inclined from horizontal in accordance with the contour of the ground or encountered soil conditions as the aerator is advanced across the earth. A bracket precludes any upward swinging movement of the arms of each unit to be resisted by the weight of the drum whenever such arms are pivoted upwardly past a predetermined elevation, in order to provide additional force where highly compacted soil conditions are found.

### RELATED APPLICATIONS

The present invention claims priority on provisional patent application, Ser. No. 60/518,622, filed on Nov. 10, 2003, entitled “Contour Aerator”.

### FIELD OF THE INVENTION

The present invention relates generally to the field of lawn and garden equipment and more particularly to an aerator.

### BACKGROUND OF THE INVENTION

It is common practice in the treating of soil to aerate the ground. Aerators are generally used to punch holes in soil to allow air and moisture and nutrients to enter the soil. The holes also serve as receptacles for seed to prevent the seed from being washed away and to promote germination and growth.

Numerous aeration devices have been available. One such device comprises a large cylindrical drum mounted about its periphery with a plurality of radially extending teeth. The teeth are conventionally mounted in circumferentially spaced rows, such that the teeth sequentially penetrate the soil as the roller rotates to create a pattern of aeration holes. The drum is pulled over the ground and, as it rolls, the teeth are driven into the soil to create holes.

While this device is widely used and has proven somewhat successful, it is nevertheless plagued with numerous problems and shortcomings inherent in its design. For example, present aerators pull up grass which destroys plugs of the lawn. One reason that aerators destroy the plugs of the lawn is that when the aerator encounters ground of differing contour, it does not pivot. Since the teeth necessarily engage the ground at an angle and are rotated laterally through the soil, significant force is required to penetrate the ground and move the spikes through the dirt.

Also, present aerators have mechanisms and/or electronics that tend to break and/or require maintenance.

Thus there exists a need for an improved aerator that does penetrates the soil and does not tear up the grass. Also, there exists a need for an improved aerator that does not tend to break and does not require maintenance.

### SUMMARY OF INVENTION

In order to overcome the above noted disadvantages, our present invention contemplates the provision of an aerator wherein each roller unit is pivotally swingable as the aerator is advanced across the ground so that the aerator shaft of each unit follows in parallel with the contour of the ground and each of the roller units pierces the earth to substantially the same depth.

Each roller unit of the aerator is provided with pivot means mounting the roller frame to the main frame.

### BRIEF DESCRIPTION OF THE DRAWINGS

FIG. 1 is an exploded perspective view of a contour aerator in accordance with one embodiment of the present invention;

FIG. 2 is a top down view of a contour aerator according to a preferred embodiment of the present invention;

FIG. 3 is a perspective view of a contour aerator according to a preferred embodiment of the present invention;

FIG. 4 is a side view of a contour aerator according to a preferred embodiment of the present invention; and

FIG. 5 is a front view of a contour aerator according to a preferred embodiment of the present invention.

### DETAILED DESCRIPTION OF THE DRAWINGS

The aerator described herein has drums that are able to pivot about the frame. The aerator also has triangular teeth that are space in a spiral about the drums. The drums have an opening that allows water, sand or other weight bearing material to be added to the drums. The spiral teeth and

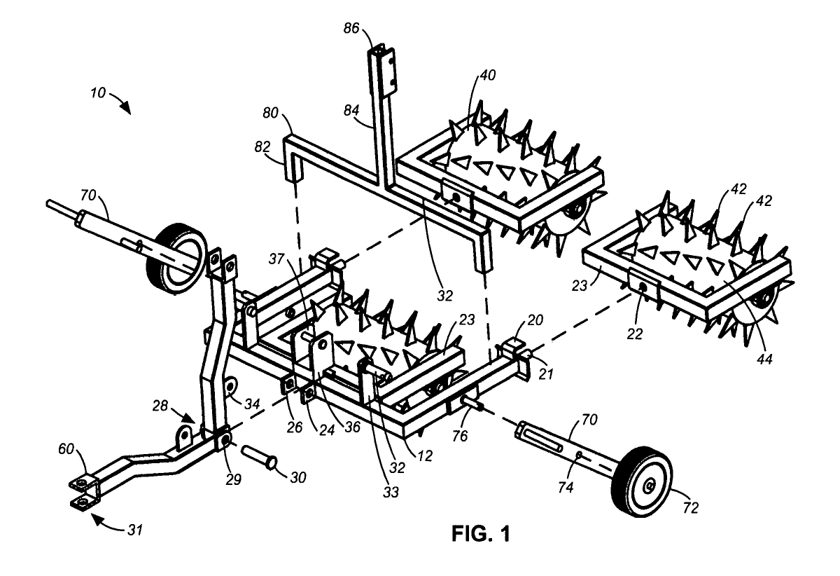

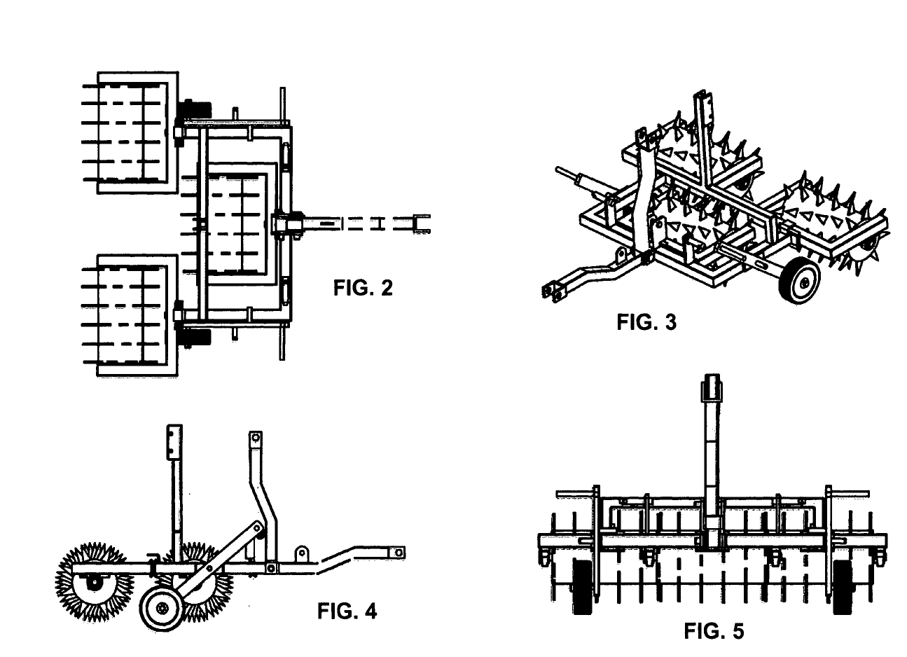

In FIG. 1, a ground hole producing apparatus 10 in accordance with one embodiment of the present invention is shown. The ground hole producing apparatus 10 is an aerator. The aerator 10 has a main frame or chassis 12. The main frame 12 is coupled to a bracket 20. The bracket 20 has a pivot pin 21 that engages a slot 22 on a secondary frame 23. The pivot pin 21 is held to the secondary frame 23 by a bolt (not shown) or welded. The main frame 12 is U-shaped and along the base has a pair of flanges 24. The flanges 24 have apertures 26. A tongue assembly 60 has a first end 28 that mates with the flanges 24 of the main frame 12. The first end 28 has an aperture 29 and cotter pin 30 extends through apertures 26 and aperture 29 to hold the tongue assembly 60 to the main frame 12. A second end 31 of the tongue assembly 60 mates to a tractor or other towing vehicle.

In another embodiment, the tongue assembly 60 is mounted vertically to allow a three point hitch. In the case the second end 31 forms one of the points of the three point hitch. The tongue assembly 60 has a protrusion 34 is coupled to a pair of flanges 36 by a cotter pin assembly 37. The second and third points of the three point hitch are formed by the pins 32 on the main frame 12. The pins 32 are attached to the main frame 12 by plates 33.

Each of the three frames 23 has a drum 40. The drum 40 is allowed to rotate 41 within the frame 23. The drum 40 has a plurality of triangular shaped spikes 42. The spikes 42 may be arranged in a spiral fashion. The drums 40 are hollow but have an access 44 that allows the user to insert weight bearing material such as water, sand, etc.

The aerator 10 has a wheel assembly 70. The wheel assembly 70 has a wheel 72 at a first end. In the middle of the wheel assembly 70 is an aperture 74 that mates with a pin 76 of the main frame 12 and is secured by a flip ring pin (not shown).

The aerator 10 may also have a seeder mount 80. The seeder mount 80 has a pair of legs 82 that are welded to the main frame 12 in one embodiment. An arm 84 of the seeder mount 80 extends up vertically. At the free end 86 of the seeder mount 80 is an attachment for mounting a seeder.

It is to be appreciated that the spike aerator 10 and its elements may be manufactured from any known materials that are durable. Preferably, metallic, alloy, or durable plastic or composite materials are used for the various elements within the spike aerator 10.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

1. An aerator comprising:
a roller;
a frame; and
a swivel connection between the roller and the frame.

2. The aerator according to claim 1, wherein the aerator further includes a seeder mount coupled to the frame.

3. The aerator according to claim 2, wherein the frame has a main frame and a plurality of secondary frames coupled to the main frame.

4. The aerator according to claim 3, wherein the frame has a main frame is coupled to the plurality of secondary frames by the swivel connection.

5. The aerator according to claim 4, wherein the roller is coupled to one of the plurality of secondary frames.

6. The aerator according to claim 1, wherein the roller is hollow.

7. The aerator according to claim 6, wherein the roller has an access for placing a weight bearing material in the roller

8. The aerator according to claim 1, wherein the aerator further includes a wheel assembly kit coupled to the fram.

9. An aerator comprising:
a roller having a plurality of triangular teeth around the roller;
a frame; and
a swivel connection between the frame and the roller.

10. The aerator according to claim 9, wherein the plurality of triangular teeth are positioned spirally around the roller.

11. The aerator according to claim 10, wherein the frame has a main frame and a plurality of secondary frames coupled to the main frame.

12. The aerator according to claim 9, further including a tongue assembly coupled to the frame.

13. The aerator according to claim 12, wherein the tongue assembly and fram may be coupled to a towing vehicle as a three point hitch.

14. The aerator according to claim 12, wherein the tongue assembly and fram may be coupled to a towing vehicle as a drawbar.

15. An aerator comprising:
a plurality of rollers;
a plurality of secondary frames coupled to the plurality of rollers; and
a main frame coupled by a plurality of swivel connection to the plurality of secondary frames.

16. The aerator according to claim 15, further including a tongue assembly coupled to the frame.

17. The aerator according to claim 16, wherein the tongue assembly and fram may be coupled to a towing vehicle as a three point hitch.

18. The aerator according to claim 16, wherein the tongue assembly and fram may be coupled to a towing vehicle as a drawbar.
